(19) United States
(12) Patent Application Publication
(10) Pub. No.: US 2016/0294760 A1
(43) Pub. Date: Oct. 6, 2016

(54) SYSTEM FOR PROMPTING EVENTS

(71) Applicant: Madeleine Eames, Salmon Arm (CA)

(72) Inventor: Madeleine Eames, Salmon Arm (CA)

(21) Appl. No.: 15/090,543

(22) Filed: Apr. 4, 2016

Related U.S. Application Data
(60) Provisional application No. 62/142,807, filed on Apr. 3, 2015.

(51) Int. Cl. H04L 12/58; G08B 3/10; G08B 6/00; G08B 5/36

(52) U.S. Cl. CPC H04L 51/24; G08B 5/36; G08B 3/10; G08B 6/00

(57) ABSTRACT

A system for prompting events to a user comprising of an attachment device for fastening to a surface and a notifying device set within attachment device. The notifying device allows for prompting events on the surface of the user and a mindfulness application communicates with the notifying device prompting events relating to a desired internal behavior. The mindfulness application primarily operates through a mobile device and sends push notifications to the wearable device at a user selected schedule. Upon receiving the notification, the wearable device notifies the user through a user selected means, thereby alerting the user to alter their behavior pattern.

### CLAIM OF PRIORITY

The present application for patent claims priority to U.S. Provisional Application No. 62/142,807 entitled “Wearable Apparatus” filed Apr. 3, 2015, the entire disclosure of which is hereby expressly incorporated by reference herein.

### BACKGROUND

1. Field

The present invention relates to a system for prompting events, and more specifically devices intended to notify a user to perform a desired internal behavior through prompting events.

2. Background

Recent consumer interest in personal notification has led to a variety of apparatuses being offered on the market. The personal notifications can vary from notifications: of phone calls, texts, e-mails; to notifications of weather changes; and, to notifications on health. With the increased social awareness in benefits of yoga, meditation and mindfulness, consumers are looking towards wearable apparatuses to practice such activities throughout the day.

Some wearable apparatuses focus on alerting the user through a repetitive mechanism. The mechanism is not linked to an additional device, and is not designed to be modified to the user.

Other wearable apparatuses provide more control to the user by connecting to a mobile device, but are designed to analyse and modify complex behaviors. These wearable apparatuses contain sensors that receive external data from the environment that is subsequently processed by internal processors that provide information to the user. The external data might correspond to: heart rate, motion sensor; temperature; moisture; and, other information received from the internet relating to the users surroundings. The external data is then processed and sent to the mobile device where the user can observe the external information and track the information through a selected period of time. Other apparatuses currently on the market send notifications from the mobile device to the wearable device, as to limit the continual observation of the mobile phone thereby keeping the users hands free. Such wearable apparatuses notify the user of: incoming phone calls, text messages, or emails; and, notify the user alerts set on the mobile device, such as appointments or timers/alarms. These wearable apparatuses are designed to reduce number of times the user is required to stop his current activity in order to look at the mobile device. As a consequence, the consumer cannot differentiate between notifications, incoming text, and incoming e-mail, resulting in confusion and increased stress. The confusion and increased stress go directly against the teachings of yoga, meditation, and mindfulness. As a result, such wearable apparatuses are not effective at notifying the consumer about the practice of yoga, meditation, and mindfulness.

Inventions such as U.S. Pat. No. 8,903,671 (Park), U.S. Pat. No. 8,357,079 (Balian), and U.S. Patent Publication No. 2008/0027363 (Brueckmann) have been devised in order to provide the user personal notifications to a wearable device.

Specifically, Park discloses an activity tracker, where the wearable apparatus tracks the activity of the user which enables personal health monitoring. Additionally, the wearable apparatus in Park can also be used to notify the user of certain reminders that were set in the mobile phone. The wearable apparatus of the Park system is quite complex, containing a processor that tracks and computes the activity of the tracker, and contains a display to inform the user. Balian discloses a wearable apparatus for initiating positive thinking. This wearable apparatus is overly simplistic for the purpose as it is not easily programmable. The Balian wearable apparatus is not connected to a mobile device and as such, the device lacks an interactive user element. Meanwhile, Brueckmann discloses a wearable apparatus intended as a therapeutic vibrating unit. As in Balian, the Brueckmann wearable device is overly simplistic as its primary function is to randomly alert the user. The user does not have any information on the alert, or any control on the type of alert or the alert pattern.

Unfortunately, these wearable apparatuses are either overly complicated and require many complex sensors and processors or are overly simplistic with little to no user input. The solution offered herein does not require complex processors and computing mechanics but does provide the user an opportunity to modify the program and to view the notifications.

A wearable apparatus is required which can alter the behavioral habits of the user, an apparatus which is easy to use, and easy to incorporate into the user's everyday life. The user should be able to have some control over the type of notification and its regularity as to suit the user and increase compliance. The wearable apparatus is required to be made from simple construction, and be durable. The method for prompting the behavioral change should be designed not only to optimally alter the habits in question, but to be seamlessly incorporated into the user's lifestyle. The communication of the wearable apparatus with a mobile device should be simple with minimal programming required from the wearable device.

### SUMMARY

In one aspect of the present invention, a system for prompting events comprising of an attachment device for fastening to a surface and a notifying device set within attachment device is provided. The notifying device allows for prompting events on the surface of a user. The system also has a mindfulness application which communicates with the notifying device prompting events relating to a desired internal behavior.

### BRIEF DESCRIPTION OF THE DRAWINGS

It will now be convenient to describe the invention with particular reference to one embodiment of the present invention. It will be appreciated that the drawings relate to one embodiment of the present invention only and are not to be taken as limiting the invention.

FIG. 1 is a perspective view of a mindfulness wearable apparatus, according to one embodiment of the present invention.

FIG. 2 is a perspective view of a notifying device used in the mindfulness wearable apparatus, according to one embodiment of the present invention.

FIG. 3 is a the top view of the notifying device, according to one embodiment of the present invention.

FIG. 4 is a profile view of the notifying device, according to one embodiment of the present invention.

FIG. 5 is a decoupled profile view of the notifying device, according to one embodiment of the present invention.

FIG. 6 is an exploded view of the notifying device, according to one embodiment of the present invention.

FIG. 6A is an enlarged rear exploded view of the button and button cavity within the cavity of the notifying device, according to one embodiment of the present invention.

FIG. 7 is an underside view of the upper surface of the notifying device, according to one embodiment of the present invention.

FIG. 8 is a perspective view of the housing of the notifying device, according to one embodiment of the present invention.

FIG. 9 is a perspective view of the attachment device used in the mindfulness wearable apparatus, according to another embodiment of the present invention.

FIG. 10 is a perspective profile view of the bolt fastener used in the attachment device, according to another embodiment of the present invention.

FIG. 11 is a method diagram for an initiation of a mobile device mindfulness application according to one embodiment of the present invention.

FIG. 12 is a method diagram for editing of the mindfulness application for the focus internal behavior according to one embodiment of the present invention.

FIG. 13 is a method diagram for editing of the mindfulness application for the gratitude internal behavior according to one embodiment of the present invention.

FIG. 14 is a method diagram for editing of the mindfulness application for the mindfulness internal behavior according to one embodiment of the present invention.

FIG. 15 is a screen shot of the initiating screen according to one embodiment of the present invention.

FIG. 16 is a screen shot of the initiating screen according to one embodiment of the present invention.

FIGS. 16A and 16B are screen shots of the prompting screen to communicate the mindfulness application with the wearable device and a subsequent successfully synced screen shot according to one embodiment of the present invention.

FIG. 17 is a screen shot of the main screen according to one embodiment of the present invention.

FIG. 18A is a screen shot of the editing screen for a desired internal behavior according to one embodiment of the present invention.

FIG. 18B is a screen shot of modifying the time for start of the day according to one embodiment of the present invention.

FIG. 19A is a screen shot of the editing of the haptic feedback pattern according to one embodiment of the present invention.

FIG. 19B is a screen shot of a complete alert schedule of a desired internal behavior according to one embodiment of the present invention.

### DETAILED DESCRIPTION

The present invention will now be described more fully hereinafter with reference to the accompanying drawings, in which preferred and other embodiments of the invention are shown. No embodiment described below limits any claimed invention and any claimed invention may cover processes or apparatuses that are not described below. The claimed inventions are not limited to apparatuses or processes having all the features of any one apparatus or process described below or to features common to multiple or all of the apparatuses described below. It is possible that an apparatus or process described below is not an embodiment of any claimed invention. The applicants, inventors or owners reserve all rights that they may have in any invention claimed in this document, for example the right to claim such an invention in a continuing application and do not intend to abandon, disclaim or dedicate to the public any such invention by its disclosure in this document.

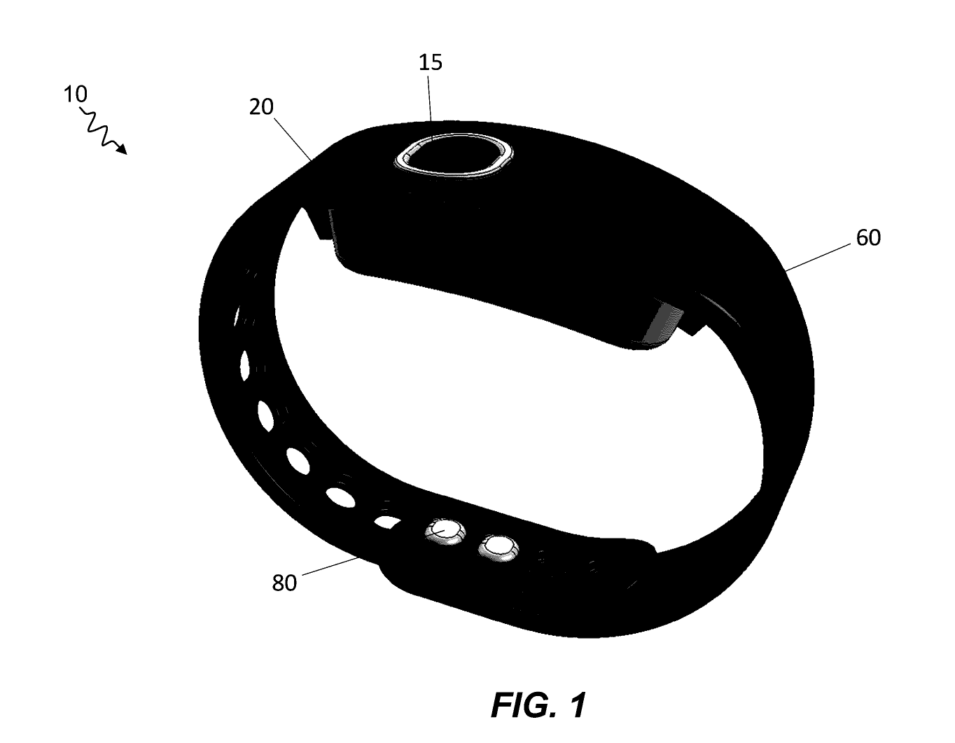

With reference to FIG. 1 and according to one embodiment of the present invention, the Mindfulness Wearable Apparatus 10 is shown in greater detail. The Mindfulness Wearable Apparatus 10 is primarily comprised of a button 15, a notifying device 20, an attachment device 60, and a bolt fastener 80. The notifying device 20 is set within the attachment device 60 which is subsequently fastened on the surface of a user (not shown) with the bolt fastener 80. The term surface in the present application is defined as being in contact or in close proximity to a user's skin. The button 15 remains exposed when the notifying device 20 is set within the attachment device 60. The purpose of the Mindfulness Wearable Apparatus 10 is to physically alert the user throughout the day to do something mindful. The Mindfulness Wearable Apparatus 10, prompts events for the user, by vibration or other means (light or sound), to perform a desired internal behavior, which may include taking a deep breath(s), a gratitude practice, or other mindful behavior, or a reminder to focus on a particular thing The Mindfulness Wearable Apparatus 10 has been designed, developed, tried and tested to be rugged, and to be contoured as to fit around the user's wrist so it can withstand the day-to-day operation.

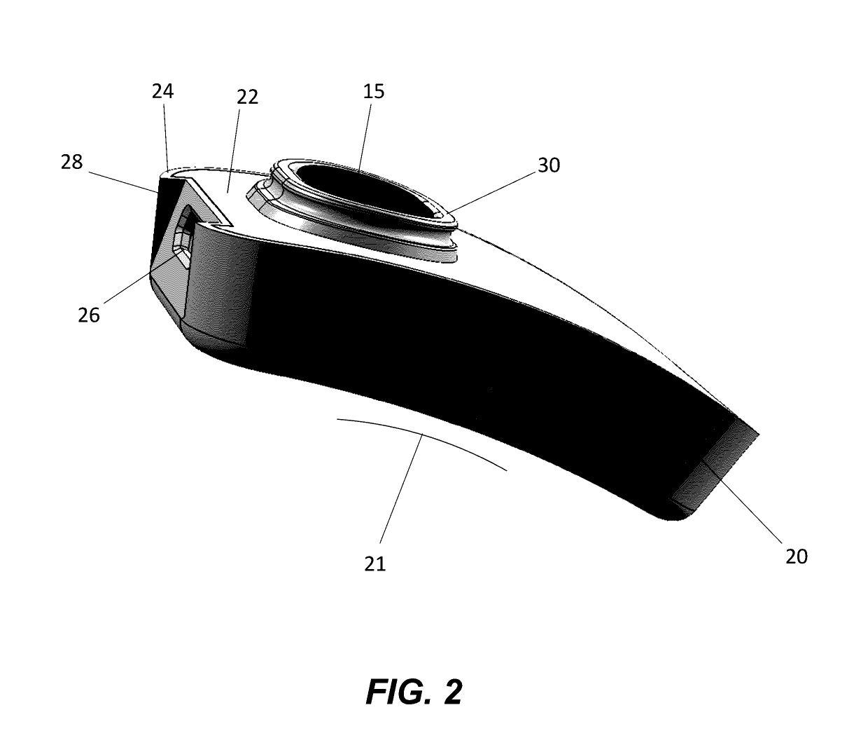

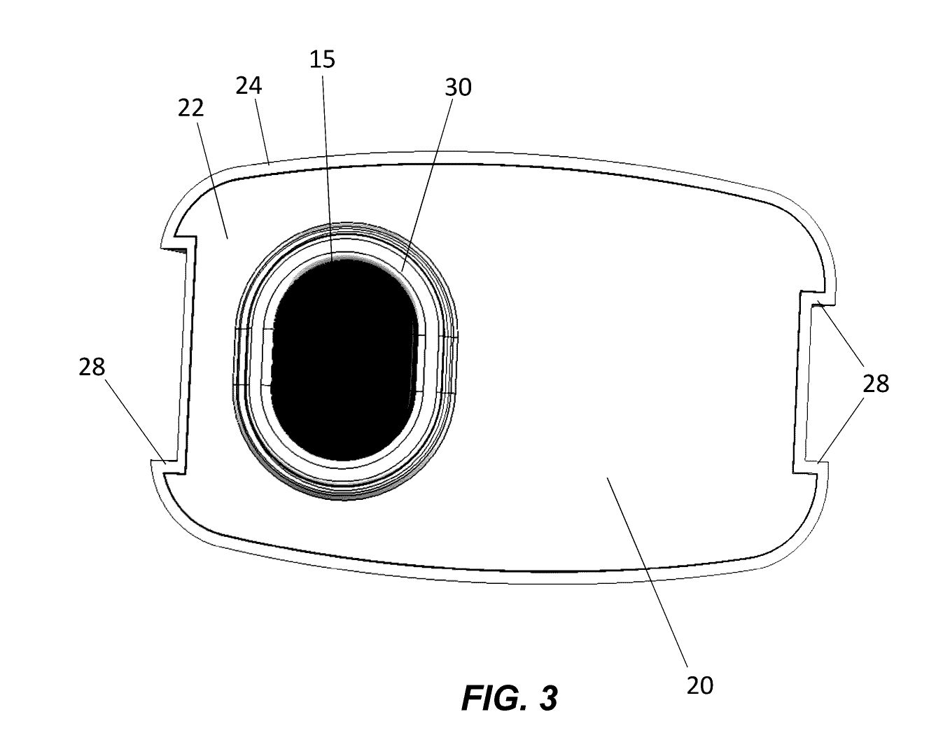

With reference to FIGS. 2 and 3, and according to one embodiment of the present invention the notifying device 20 and the button 15 are described in greater detail. The notifying device 20 is formed from an arched housing 24 forming a cavity 21 which allows for better placement on the user's wrist (not shown). The notifying device cover 22 replicates the arc, thereby giving the notifying device a curved shape. A beveled protrusion 30 encircles a bore (not shown) that adorns the outer face of the notifying device cover 22. The button 15 is set within the bore (not shown) on the face of the notifying device cover 22. The shoulders of the notifying device contains upper edge extensions 28. In between the upper edge extensions 28, the flat plane 25 contains a charging aperture 26. The shape of the charging aperture 26 relates to the shape of the docking pin (not shown). The hexagonal shape of the charging aperture 26 is only one representation. A worker skilled in the relevant art can appreciate the various shapes of charging ports known in the art. With specific reference to FIG. 3, an aerial view of the notifying device 20 with the button 15 is shown. The upper edge extensions 28 are shown on both shoulders of the notifying device 20. The notifying device cover 22 is fitted within the notifying device housing 24. The fitment of the notifying device cover 22 within the notifying device housing 24 encapsulates and seals the interior chamber (not shown) of the notifying device.

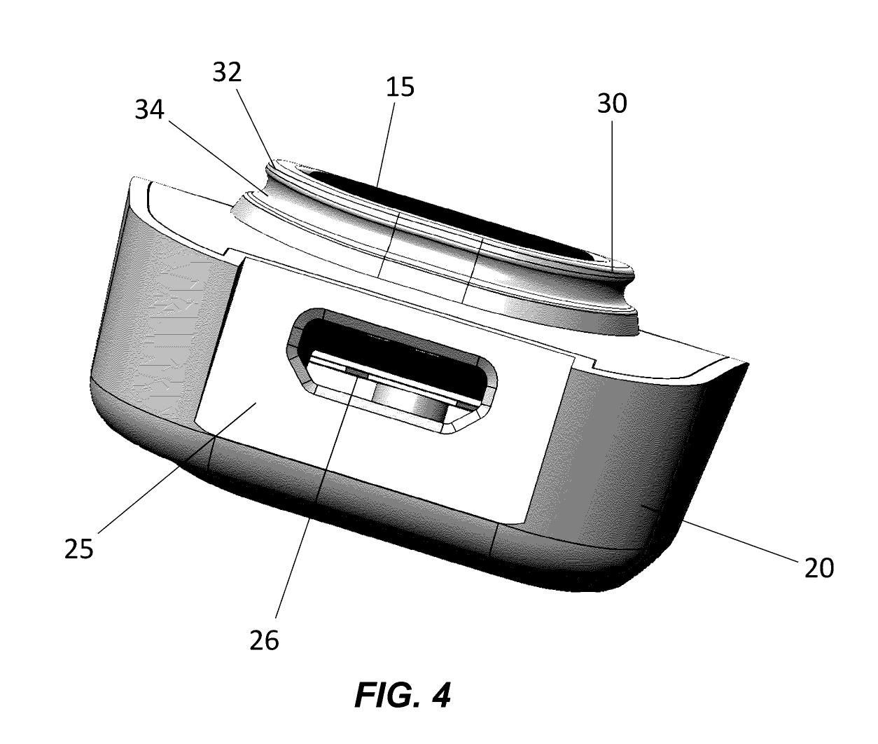

With reference to FIG. 4 and according to one embodiment of the present the side view of the notifying device 20 with the button 15 is shown. The charging aperture 26 is clearly visible on the flat plane 25. The beveled protrusion 30 is seen in greater detail. The beveled protrusion contains an upper lip 32 and a groove 34. The upper lip 32, with its smooth rounded edges enhances the feel and usability of the button 15. The groove 34 is used for a tight fitment of the attachment device (not shown) around the notifying device 20. The attachment device (not shown) fits within the groove 34.

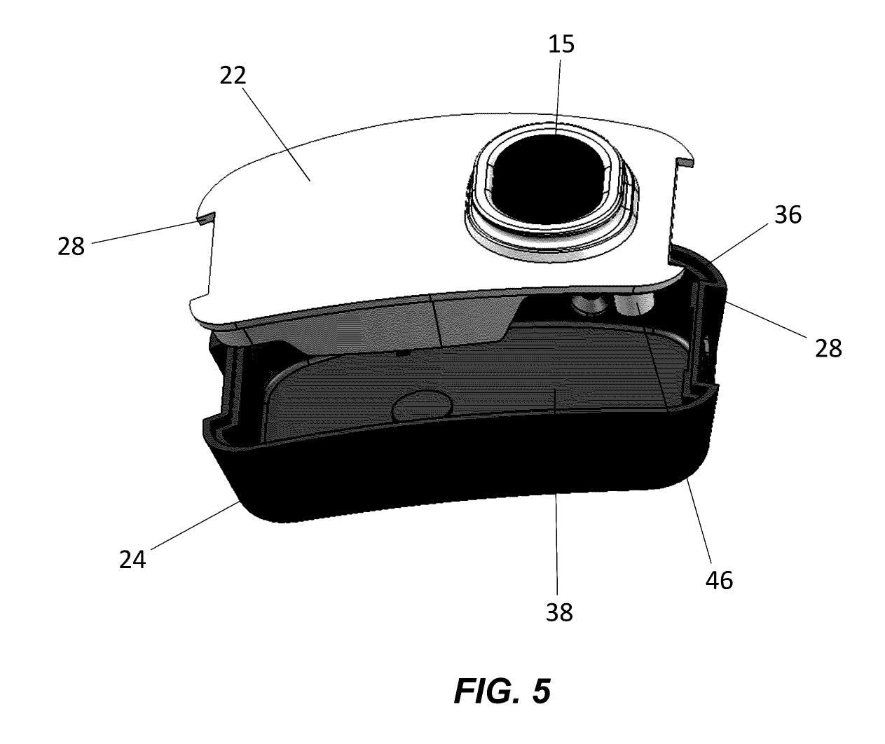

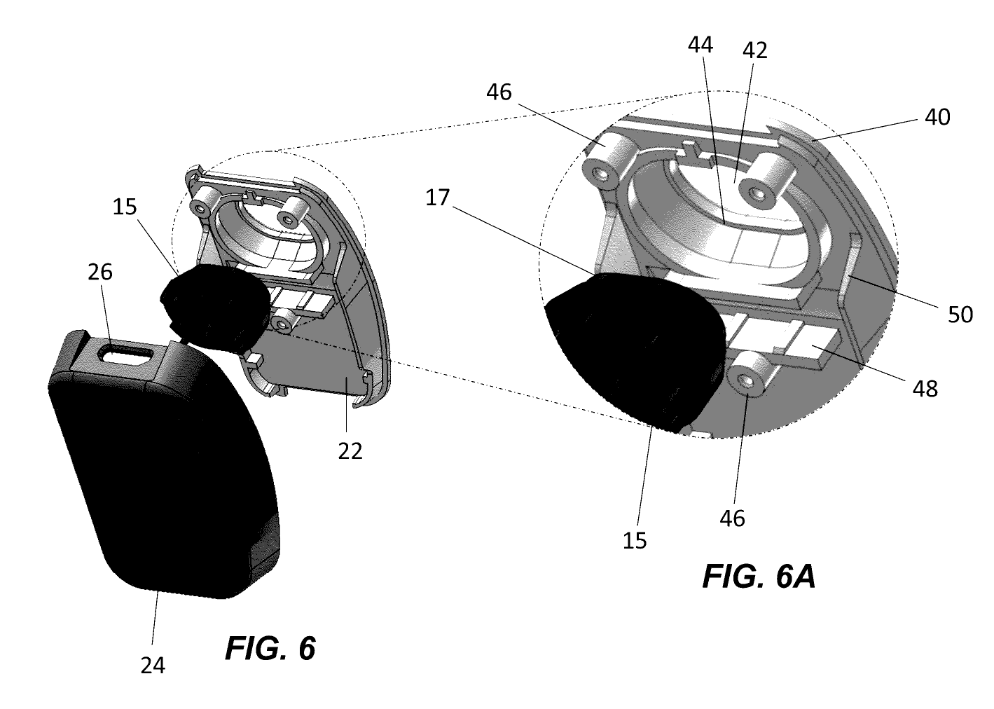

With reference to FIGS. 5 and 6 and according to one embodiment of the present invention the exploded view of the notifying device 20 holding the button 15. The notifying device cover 22 rests on the housing ledge 36 as the notifying device cover 22 is fitted within the notifying device housing 24. Screw columns 46 and side walls 50 maintain the integrity of the notifying device 20 as pressure is added to the notifying device cover 22. With specific reference to FIGS. 6 and 6A, the fitment of the notifying device cover 22 and the button 15 within the notifying device housing 24 is shown in greater detail. The cover platform 40 sets onto the housing ledge 36 and ensures proper fitment. Upon placement of the notifying device cover 22 onto the notifying device housing 24, the inner chamber 38 is encapsulated. The inner chamber 38 is wherein the printed circuit board (not shown), the battery (not shown) and the vibration motor (not shown) are housed. A worker skilled in the art would appreciate the various methods known in the art of encapsulating the inner chamber 38.

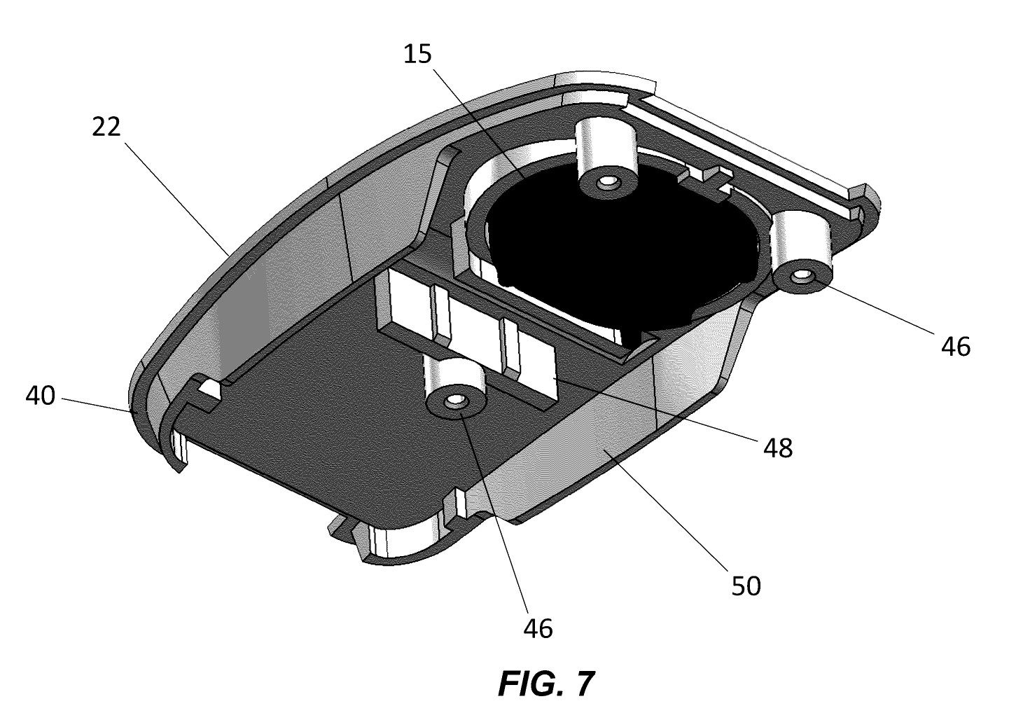

With reference to FIG. 7 and according to one embodiment of the present invention the underside of the notifying device cover 22 is shown with the button 15. The button 15 is shown in its fully elevated, relaxed position within the notifying device cover 22. The button 15 has the ability to move along the vertical axis through a distance of the side walls 50 and screw columns 46 and interact with the printed circuit board (not shown). The bracing beam 48 adds another level of strength and rigidity to the notifying device cover 22. The cover platform 40 encompasses the entire lower region of the notifying device cover 22.

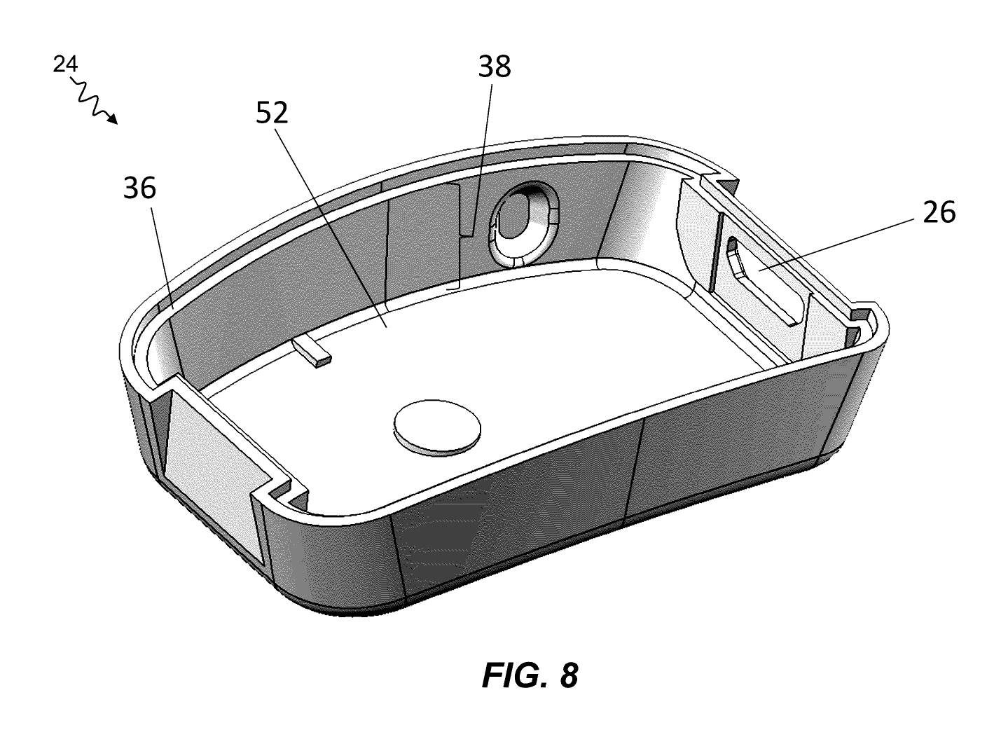

With reference to FIG. 8 and according to one embodiment of the present invention the notifying device housing 24 is shown in greater detail. The depth of the inner chamber 38 can be seen as the distance from the floor 52 to the housing ledge 36. The charging aperture 26 can be seen on the shoulder of the notifying device housing 24.

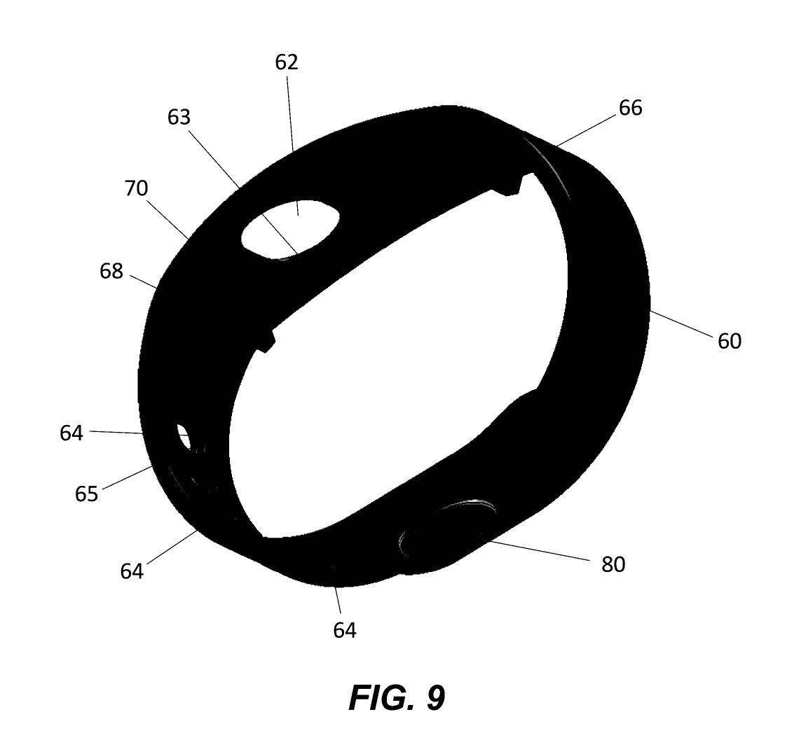

With reference to FIG. 9 and according to one embodiment of the present invention the attachment device 60 is shown with the bolt fastener 80. The attachment device 60 is primarily comprised of a long rectangular flexible material. The ends of the attachment device 60 fold over to form a loop which can be subsequently placed on the user. A worker skilled in the relevant art would appreciate the manner in which the mindfulness wearable apparatus (not shown) can be positioned on the user, whether it is on one of the user's appendages, or around the neck or chest or placed in a pocket. Regardless of the location on the user, the mindfulness wearable apparatus is placed on the surface of the user. For example, the attachment device could be a bracelet, a necklace, or a clip. The positioning on the user is dependent on the attachment device 60. The first and second extension fingers 66 and 68, respectively, hold the notifying device (not shown) within the attachment device 60. A round passage 62 is centrally positioned along the attachment device 60. Upon setting of the notifying device (not shown) in between the first and second extension fingers 66 and 68 and thus onto the attachment device 60, the corresponding button (not shown) is positioned to penetrate the round passage 62. The mounting device plug 70 is positioned on the second extension finger 68 and is shaped to correspond to the charging aperture (not shown). A worker skilled in the relevant art would appreciate that the mounting device plug needs to match the charging aperture (not shown), and would be modified based on the type of charging aperture (not shown) used. The mounting device plug 70 has two practical applications. First, the mounting device plug 70 ensures proper fitment and hold of the first and second extension fingers 66 and 68 to the notifying device (not shown). The mounting device plug 70 prevents the notifying device (not shown) from movement between the first and second extension fingers 66 and 68. Second, the mounting device plug 70 prevents water and debris from entering the notifying device (not shown) through the charging aperture (not shown). Preventing water and debris from entering the notifying device (not shown) protects the printed circuit board (not shown), the battery (not shown) and the vibration motor (not shown). Multiple bores 64 adorn the outer edges of the attachment device. The bores 64 are used to fasten the attachment device 60, and thus the Mindfulness Wearable Apparatus (not shown) around one of the user appendage. The bores 64 are placed sequentially and equidistantly from each other. One side of the attachment device contains 2 bores, which are hidden by the bolt fastener 80, while the other side of the attachment device contains numerous amounts of bores 64. Depending on the width of the user's appendage (not shown), the diameter of the loop that is formed by the attachment device 60 can be altered depending on the bores 64 selected on both ends of the attachment device 60. The bores 64 and the round passage 62 contain centrally positioned first and second O-rings, 65 and 63 respectively. The first and second O-rings, 65 and 63 function as securing devices. The first O-ring 65 secures around the bolt fastener 80. The second O-ring 63 secures around the groove on the beveled protrusion of the notifying device cover (not shown).

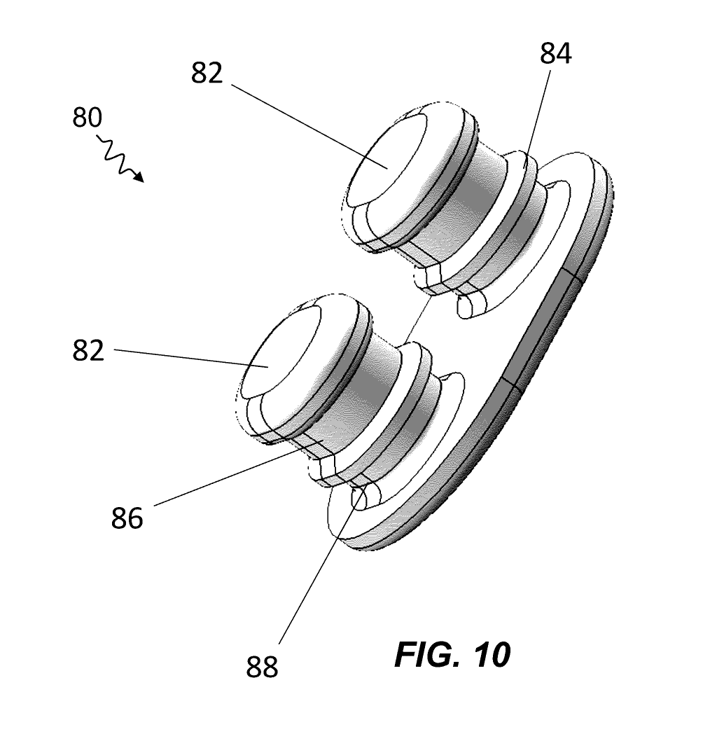

With reference to FIG. 10 and according to one embodiment of the present invention, the bolt fastener 80 is shown in greater detail. The bolt fastener 60 contains 2 bolts 82 for securement onto the attachment device (not shown). Each bolt 82 contains an upper and lower trough 86 and 88, respectively. The depth of the lower trough 88 permits the setting of the one side of the attachment device containing 2 bores (not shown), while the larger depth of the upper trough 86 permits the setting of the side of the attachment device containing multiple bores (not shown).

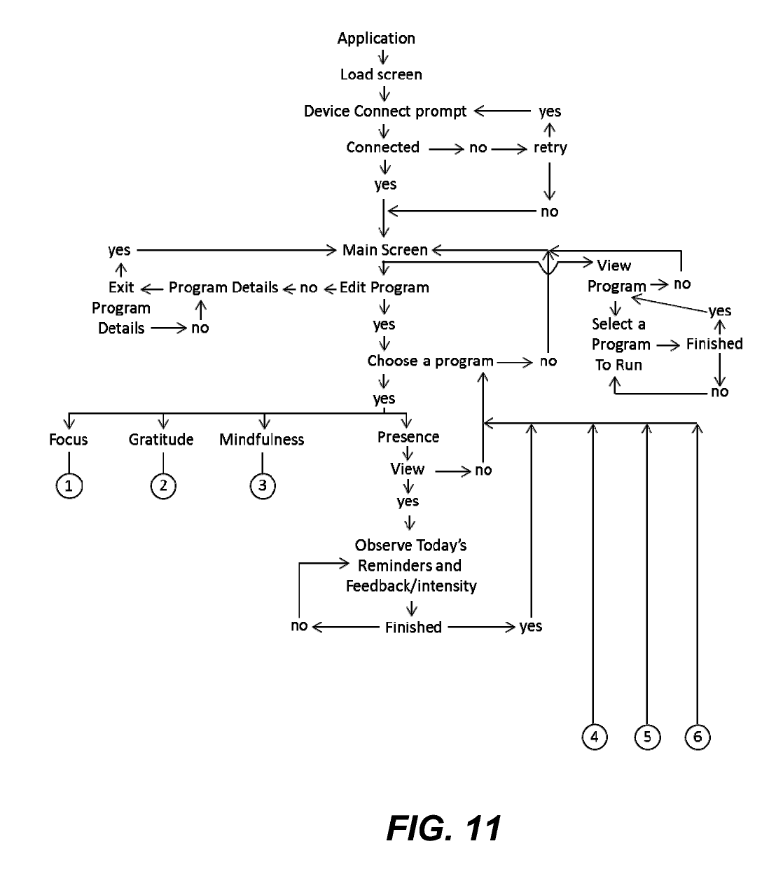

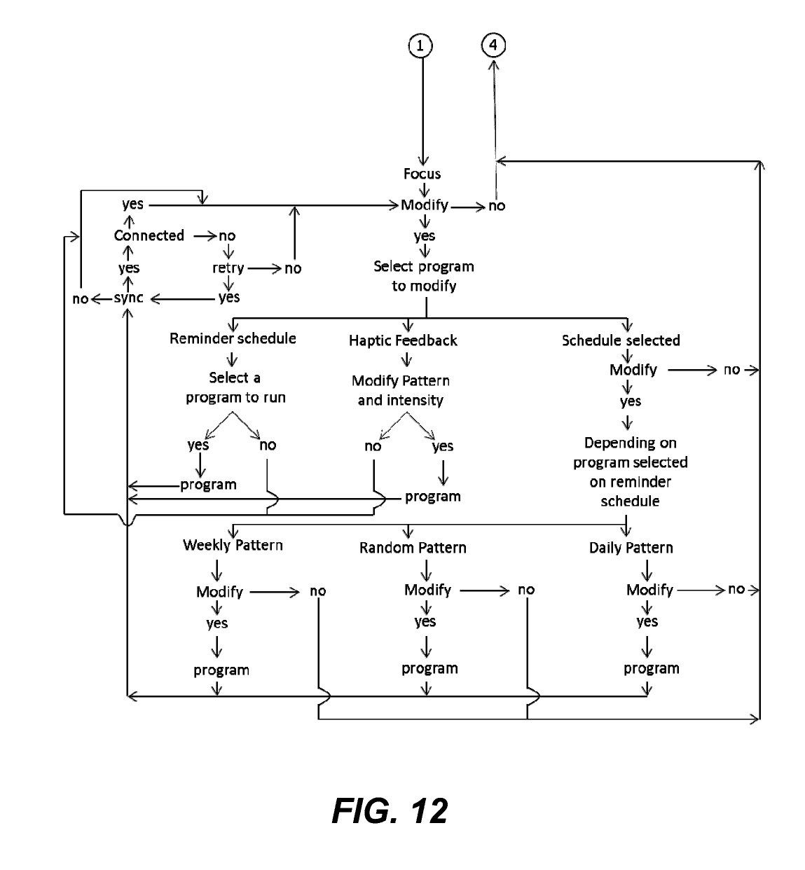

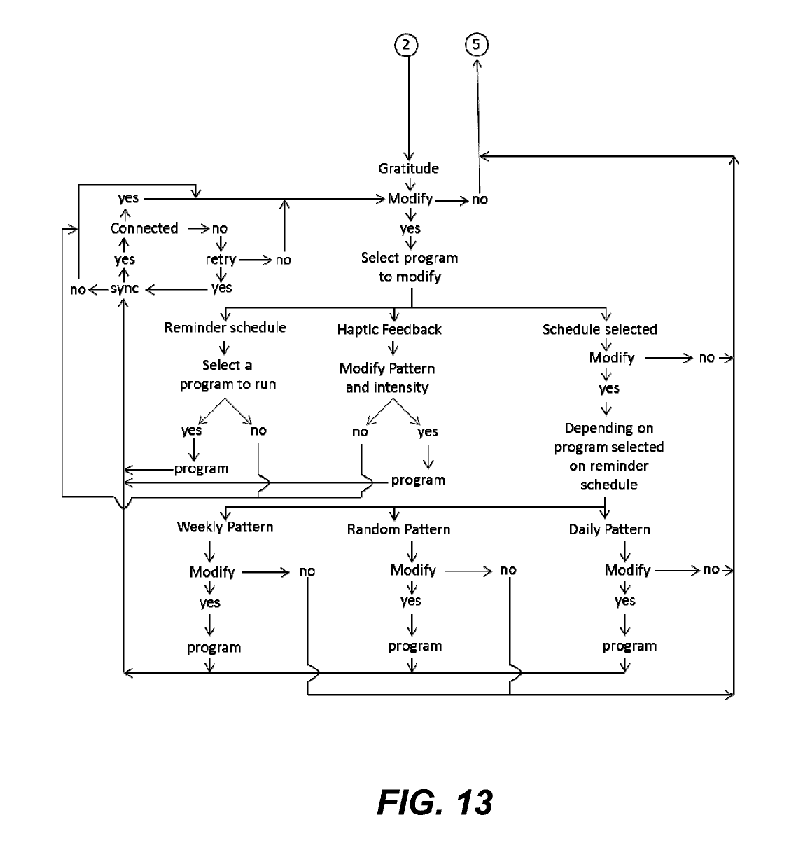

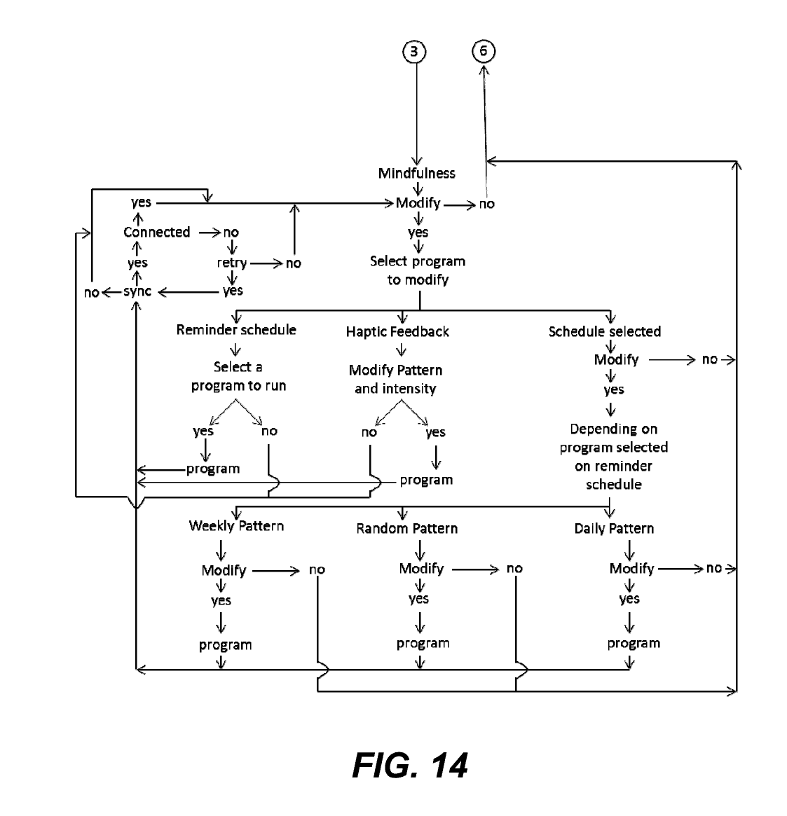

With reference to FIGS. 11 to 14 and according to one embodiment of the present invention, a method diagram is shown. The method diagram relates to the mobile device mindfulness application, which allows the user to configure the mindfulness application on the mobile device and sync it with the wearable device. The process of syncing allows the mindfulness application to communicate with the notifying device (not shown) and transmits a predetermined sequence of signals as defined by the selected prompting events as outlined by the method diagram. An example of sequence of signals could be a vibration of the notifying device every 15 minutes over an 8 hour timespan. The sequence of signals can be varied by the user within the mindfulness application. A worker skilled in the relevant art would be familiar that the sequence of signals can be a number of signals including vibration, light emittance, sound emittance, or a combination thereof. The method diagrams show the mindfulness application relating to the modification of three of the possible desired internal behaviors: focus, as shown in FIG. 12; gratitude, as shown in FIG. 13; and, mindfulness, as shown in FIG. 14. The three depicted desired internal behaviors are only an example of the possible desired internal behaviors a user may wish to modify. A user may wish to modify the programs by changing the internal behaviors the Mindfulness wearable apparatus attempts to modify, or by adding new programs for the additional behaviors. With Specific reference to FIG. 11, the initiation of the mobile device mindfulness application is shown. As the mindfulness application is initiated, the application attempts to communicate with the wearable device. As the mindfulness application can be altered in the absence of the wearable device, the method allows the user to continue without a connection. Upon entering the main screen, the user has a choice to view a program, select a program, or edit any of the programs currently available. Upon editing a program or viewing a program, the user is returned to the main screen. Upon selecting a program to edit, the user can select presence, which outlines the present day's desired internal behaviors set reminders and set reminder intensity. The editing of the desired internal behaviors is outlined in FIGS. 12-14. FIG. 12 relates to the editing of mindfulness application's for the focus internal behavior. FIG. 13 relates to the editing of mindfulness application's for the gratitude internal behavior. FIG. 14 relates to the editing of mindfulness application's for the mindfulness internal behavior.

With further reference to FIGS. 12-14 and according to one embodiment of the present invention, the editing program sequence is the same between the desired internal behaviors. Upon selection of the desired internal behavior application to edit, the user will be asked whether they wish to modify the program. If the user wishes not to modify the program, the user will be sent back to choosing a program to edit. The user, upon selecting to modify the program can modify the currently selected program, or select from either a reminder schedule or haptic feedback. When haptic feedback is selected, the user can modify the pattern and intensity of the reminders that the user receives on their wearable device. When reminder schedule is selected, the user can select from predetermined schedules. Upon selection of the program in the remainder schedule, that selected program appears in the schedule selected selection. The user can subsequently modify the pattern of alerts of the selected program. The pattern of alerts of the selected program can be modified to: a daily pattern; a random pattern; or a weekly pattern. Once the modification of the program is complete, the user has an option to sync the program with the wearable apparatus. Upon completion of the program edit, the user is returned to choose a program screen, where the user can return to the main screen or edit another desired internal behavior program.

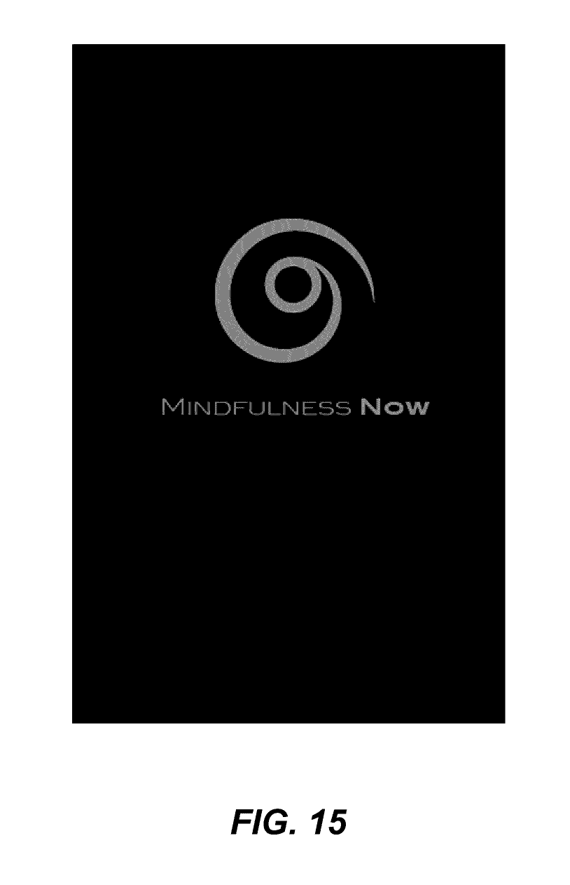

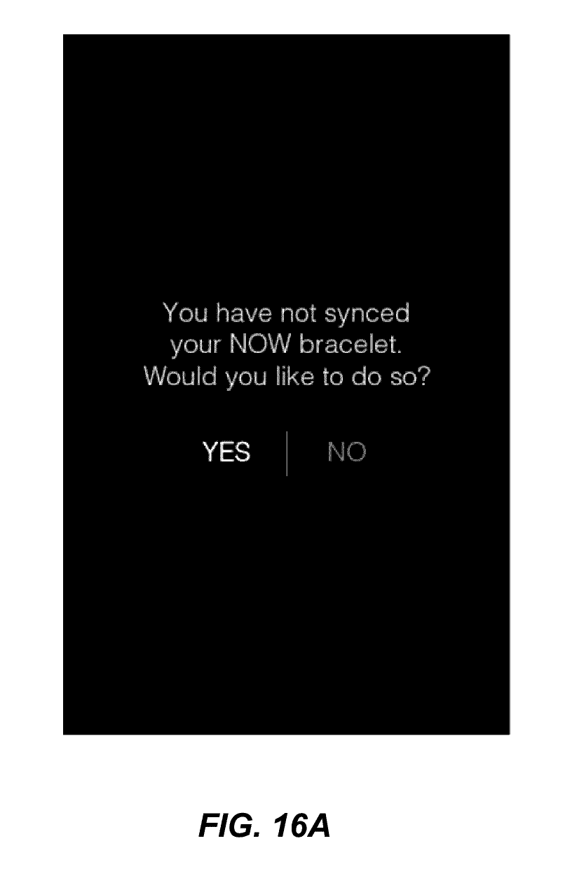

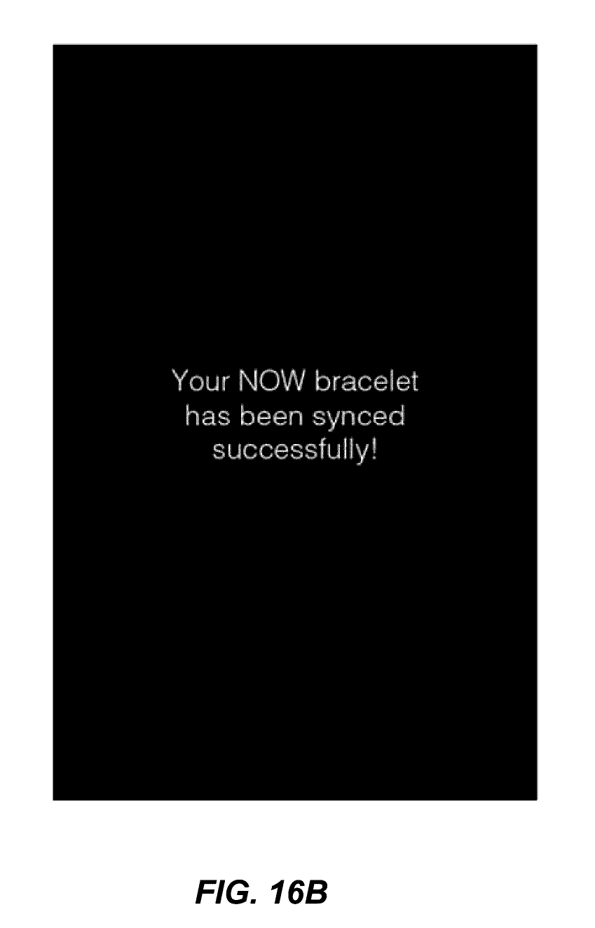

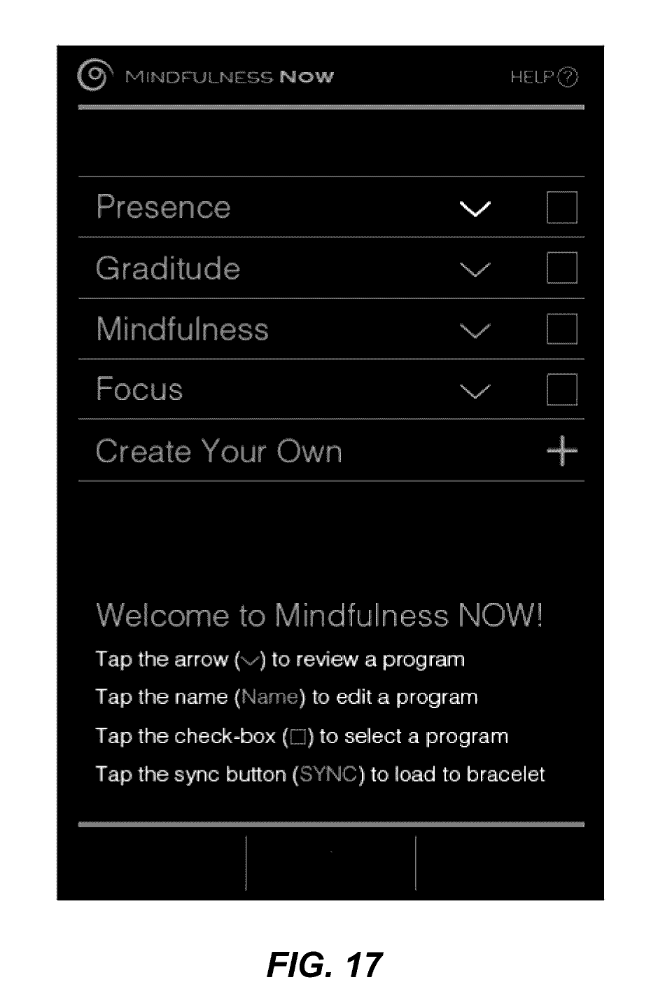

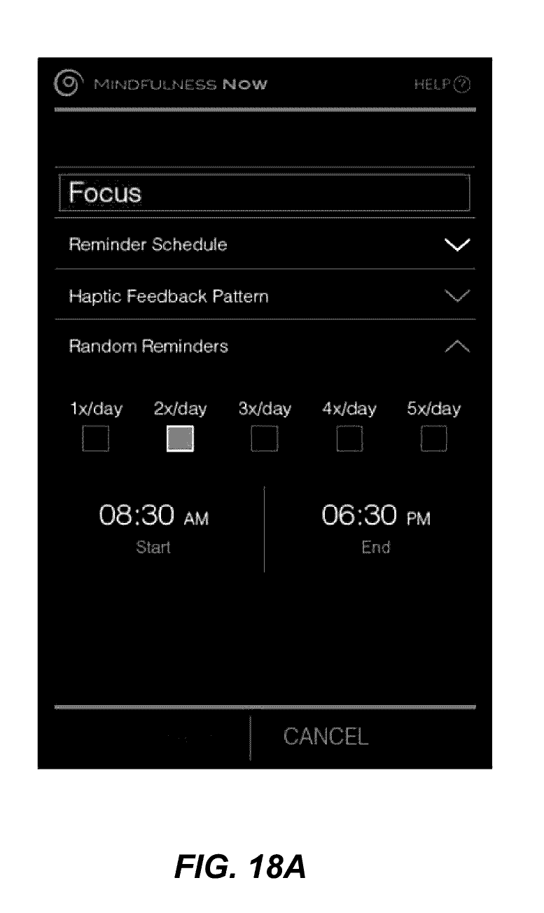

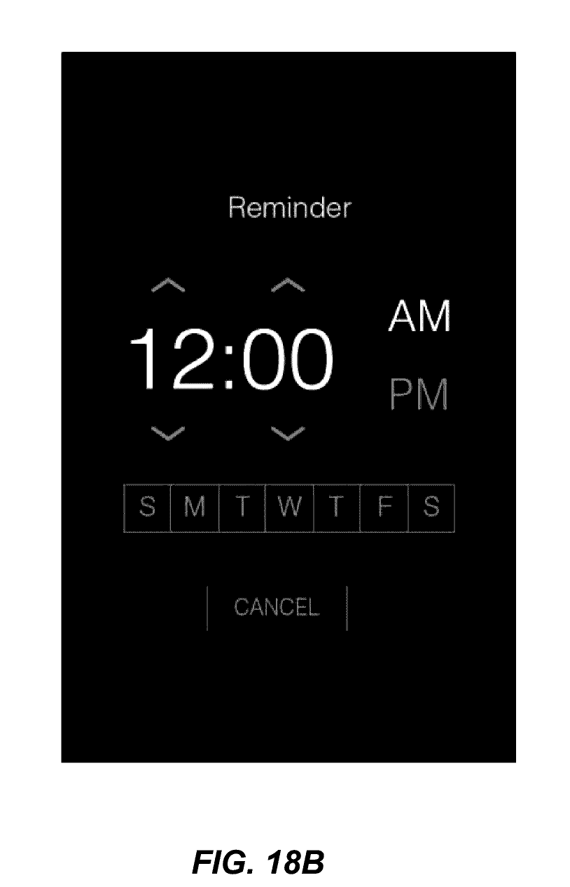

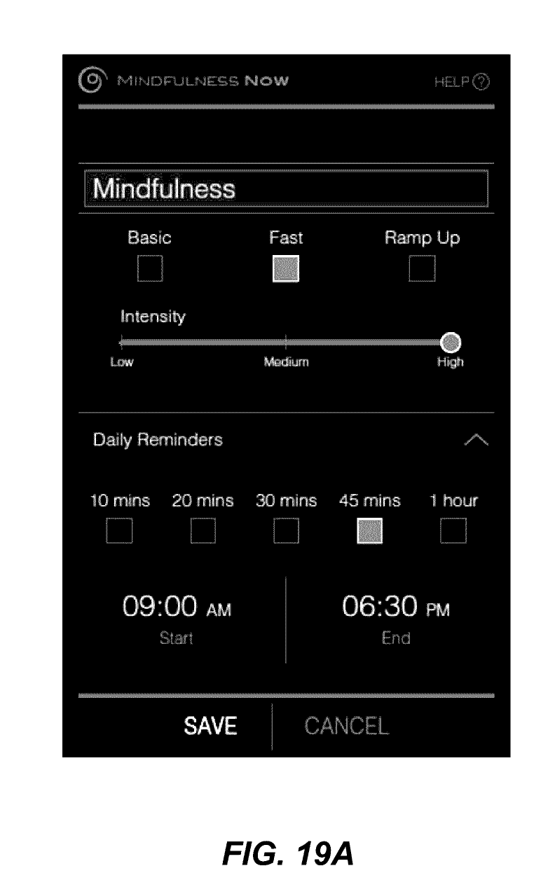

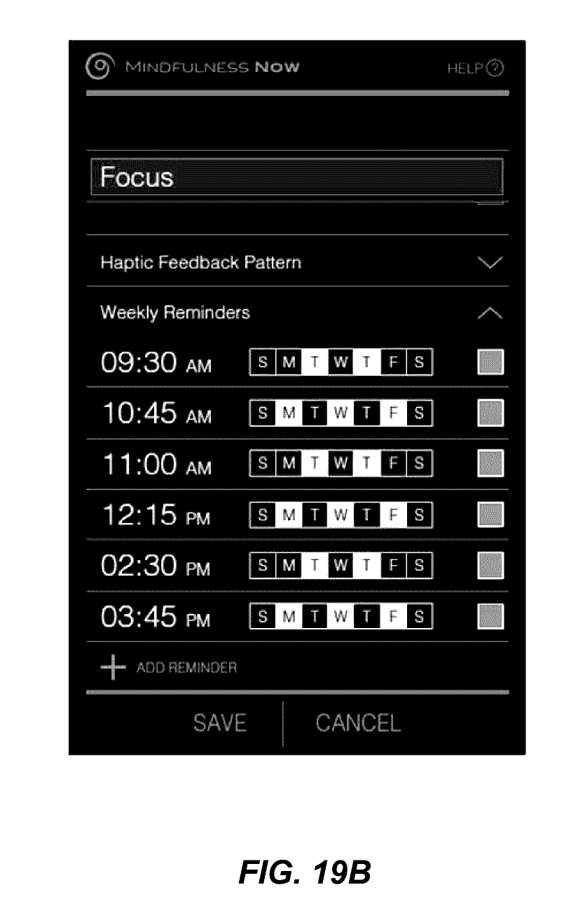

With reference to FIGS. 15 to 19 and according to one embodiment of the present invention, representative mobile device screen shots of the mindfulness application. FIG. 15 is a representative screen shot of the initiating screen. FIGS. 16A and 16B are representative screen shots of the prompting screen to communicate the mindfulness application with the wearable device and the subsequent successfully synced screen shot. FIG. 17 is representative screen shots of the main screen. FIG. 18A is a representative of editing screen for a desired internal behavior. The selected edit relates to a random reminder selection indicating the selected length of the day and the amount of reminders a day. FIG. 18B is a representative screen shot of modifying the time for start of the day. A similar screen shot is provided by the mindfulness application at any point the user wishes to set a time point. FIG. 19A is a representative screen shot for the editing of the haptic feedback pattern. The screenshot shows that the user can select the type of alert, and the intensity. FIG. 19B is a representative screen shot of a complete alert schedule of a desired internal behavior, in this case focus. The schedule is set with reminders set at different time points throughout the day, set on a weekly schedule.

The present invention provides a system for prompting events comprising of an attachment device for fastening to a surface and a notifying device set within attachment device is provided. The notifying device allows for prompting events on the surface of a user. The system also has a mindfulness application which communicates with the notifying device prompting events relating to a desired internal behavior.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated invention which is not to be limited to the specific embodiment disclosed.

Also, it is noted that the aspects of the present disclosure may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums and, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing or containing instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines and/or devices.

Furthermore, aspects of the disclosure may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing aspects of the disclosure are merely examples and are not to be construed as limiting the invention. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. A system for prompting events comprising:
an attachment device for fastening to a surface;
a notifying device set within the attachment device, said notifying device allowing for prompting events on the surface; and
a mindfulness application to communicate with the notifying device, said communication prompting events relating to a desired internal behavior.

2. The system of claim 1, wherein said attachment device for fastening to a surface is a bracelet.

3. The system of claim 1, wherein said attachment device for fastening to a surface is a necklace.

4. The system of claim 1, wherein said attachment device for fastening to a surface is a clip.

5. The system of claim 1, wherein prompting events is comprised of a sequence of signals.

6. The prompting events of claim 6 wherein said sequence of signals is comprised of either vibration means, sound notification, or flashing lights or a combination thereof.

7. The system of claim 1 wherein said prompting events can be varied by interval and repetition.
